(19) United States
(12) Patent Application Publication
(10) Pub. No.: US 2005/0186822 A1
(43) Pub. Date: Aug. 25, 2005

(54) Hybrid connector

(75) Inventors: Donald A. Serino, Plymouth, MA (US); Sharon Thomas, Camp Hill, PA (US)

Correspondence Address: LAHIVE & COCKFIELD, LLP., 28 STATE STREET, BOSTON, MA, 02109, US

(73) Assignee: ALDEN PRODUCTS COMPANY, Brockton, MA (US)

(21) Appl. No.: 11/021,505

(22) Filed: Dec. 22, 2004

Related U.S. Application Data
(60) Provisional application No. 60/532,708, filed on Dec. 26, 2003.

(51) Int. Cl. H01R 13/213

(52) U.S. Cl. 439/320

(57) ABSTRACT

A hybrid receptacle coupler (10,30,50) having at least two modes of coupling, for coupling with complementary plug couplers having disparate coupling modes. A camming latch (12,32,52) is defined on the external surface (16,36,56) for quick connect/disconnect coupling with a quick connect/disconnect coupler (300). Threading (20,40,58,60) is defined on the internal surface (18), or the external surface (32), or on both the internal and external surfaces (52,62) for threaded coupling with threaded plug couplers (100,200).

### RELATED APPLICATIONS

The present application claims priority to U.S. Provisional Patent Application Ser. No. 60/532,708, filed Dec. 26, 2003, the contents of which are herein incorporated by reference.

### FIELD OF THE INVENTION

The present invention relates to the field of electrical connectors for joining a first connector body with a second connector body, and more particularly to data signal connectors.

### BACKGROUND OF THE INVENTION

Connector systems are used for a variety of applications, such as electrical, fluidic, mechanical, optical, hydraulic or pneumatic systems, to provide a connection between various components and devices. Connector systems generally include a first connector half, which may house a receptacle, and a complementary second connector half, which may house a plug configured to mate with the receptacle. The first and second connector halves couple to each other to couple the receptacle and the plug together.

For example, it is known from U.S. Pat. Nos. 5,067,909 and 5,167,522 to use an assembly for coupling together a pair of complementary multicontact electrical connectors using a simple, quick pushing-together motion, and to decouple them simply and easily. Such couplers are also sold by Alden Products Co. of Brockton, Mass. under the trademark PULSE-NET or PULSE-LOCK. To operate such systems, one of the connector halves is held in a first coupler housing to be pushed into coupling with a complementary second coupler housing half containing the other connector. The connectors should be held stationary in the appropriate mating orientation within the coupler housings when pushed together, while the coupling action is accomplished by coupler components that relatively move with respect to the connectors. The first coupler housing includes movably secured therearound a latching collar at its forward end that automatically moves slightly in a rotational direction against spring bias during coupling, whereafter it latches in position thus fully mating the contained connectors. The latching collar is slightly rotated manually against the spring bias for delatching and decoupling when the assembly is simultaneously pulled away. The other connector is held by its associated second coupler housing in a panel-mounted position, for example, such as in the chassis or housing of an electrical or electronic apparatus.

The connectors may be known data signal connectors such as RJ45 plugs and receptacles with standard shape and size for termination onto multiconductor cable. Other connectors are known that have a plurality of pin and socket terminals.

An industry standard for connector couplers is also known with the identification “M12” that provides for the coupling of plug and receptacle connector pairs, where the couplers have complementary threaded coupling surfaces wherein the plug coupler includes a coupling ring that must be rotated with respect to the receptacle coupler until fully coupled, at which moment the connectors mounted within the plug and receptacle couplers are in a fully mated condition.

It is desired to provide a quick connect/disconnect receptacle coupler that is also backwards compatible for coupling with standard threaded plug couplers.

### SUMMARY OF THE INVENTION

The present invention provides a hybrid connector half, such as a receptacle coupler, capable of coupling to a plurality of different plug couplers. The hybrid receptacle coupler includes a first mating mechanism for mating with a first plug coupler and a second mating mechanism for mating with a second plug coupler. The hybrid receptacle coupler may have mounted therein a conventional receptacle connector that may be matable with either of two types of plug couplers via the first mating mechanism or the second mating mechanism. For example, one of the first and second mating mechanisms may comprise threads to allow the hybrid receptacle coupler to mate with a standard threaded coupler, such as the Ml 2 standard. One of the first and second mating mechanism may comprise a camming latch for mating with a quick connect/disconnect plug coupler having a spring-biased coupler sleeve that self-rotates to lock with the camming latch of the receptacle coupler, upon the plug coupler being aligned with and then simply pushed towards the hybrid receptacle coupler. Another type of mating mechanism may be a bayonet-type of mating mechanism. The first and/or second mating mechanism may comprise any suitable mating means suitable for coupling the hybrid receptacle coupler to another connector half.

A first embodiment of the hybrid receptacle coupler of the present invention includes a receptacle section with a camming latch defined on the outer surface, and also a threaded outer surface, for mating with either a quick connect plug coupler or a standard M12 plug coupler with coupling ring mounted and freely rotatable therearound having a threaded inner surface. A second embodiment of the receptacle coupler of the present invention includes a receptacle section with a camming latch defined on the outer surface, and also a threaded inner surface, for mating with either a quick connect plug coupler or a standard M12 plug coupler with a coupling ring mounted and freely rotatable therearound having a plug section having a threaded outer surface. A third embodiment of such a receptacle coupler includes threading on both the inner and outer surfaces, for coupling with any of the above-mentioned plug couplers.

According to one aspect of the invention, a hybrid coupler is provided. The hybrid coupler comprises a substantially tubular connector body having an outer surface and an inner surface, a first mating mechanism disposed in a first location on the body for coupling the tubular connector body to a first complementary connector half and a second mating mechanism disposed in a second location on the body for coupling the tubular connector body to a second complementary connector half.

According to another aspect of the invention, a receptacle coupler is provided. The receptacle coupler comprises a substantially tubular connector body having an outer surface and an inner surface, a camming latch and a threading. The camming latch is defined on the outer surface of the substantially tubular connector body for selectively coupling the tubular connector body to a complementary quick connect/disconnect plug coupler. The complementary quick connect/disconnect plug coupler has a first body having a rotatable collar mounted thereon, a spring for biasing the collar in a selected angular orientation and a cam follower protrusion formed on an inner surface of the collar configured to mate with the camming latch to automatically couple the plug coupler to the receptacle coupler. The threading is defined on one of the outer surface and the inner surface for selectively coupling the tubular connector body to a threaded plug coupler. The threaded plug coupler has a coupling ring mounted and freely rotatable therearound and a plug section having a threaded surface for mating with the threading on the substantially tubular connector body.

According to still another aspect of the invention, a connector system is provided, which comprises a hybrid receptacle coupler, a first plug matable with the hybrid receptacle coupler and a second plug matable with the hybrid receptacle coupler. The hybrid receptacle coupler comprises a body, first mating mechanism disposed on a first location on the body and a second mating mechanism disposed on a second location on the body. The first plug has a first complementary mating mechanism configured to mate with the first mating mechanism to selectively couple the hybrid receptacle coupler to the first plug. The second plug has a second complementary mating mechanism configured to mate with the second mating mechanism to selectively couple the hybrid receptacle coupler to the second plug.

### BRIEF DESCRIPTION OF THE DRAWING

Embodiments of the present invention will now be described by way of reference to the accompanying drawings, in which:

FIGS. 1 and 2 illustrate the PRIOR ART plug connector with coupling ring having an externally threaded plug section (FIG. 1), and coupling ring having internal threading (FIG. 2);

FIGS. 3 and 4 are isometric views of the PRIOR ART complementary quick connect/disconnect couplers, with the plug coupler having a self-rotating collar that is cammed and latches with the receptacle coupler upon mating;

FIGS. 5 and 6 are isometric and cross-sectional views of the hybrid receptacle coupler of the present invention, having both the quick connect/disconnect camming latch and threading on the internal surface;

FIGS. 7 and 8 are isometric and cross-sectional views of the hybrid receptacle coupler of the present invention, having both the quick connect/disconnect camming latch and threading on the external surface; and

FIG. 9 is a cross-sectional view of a hybrid connector having both internal and external threading,

### DETAILED DESCRIPTION OF THE PREFERRED EMBODIMENT

The present invention provides a hybrid connector half, such as a hybrid receptacle coupler, capable of connecting to different types of plug couplers. The present invention will be described below relative to an illustrative embodiment relative to a receptacle coupler. Those skilled in the art will appreciate that the present invention may be implemented in a number of different applications and embodiments and is not specifically limited in its application to the particular embodiments depicted herein. For example, the invention is applicable to plug couplers as well, and is not limited to receptacle couplers. In addition, the invention is not limited to the illustrative and described mating mechanisms, and may include any suitable mating mechanism for coupling a first connector half to a second connector half.

A hybrid connector half, such as a receptacle coupler, of an illustrative embodiment of the invention may include a first mating mechanism for coupling the hybrid connector half to a first complementary connector half and a second mating mechanism for selectively coupling the hybrid connector half to a second complementary connector half. For example, for a hybrid receptacle connector, the first mating mechanism may comprise threads or another suitable mating mechanism for coupling the hybrid receptacle connector to a threaded complementary plug coupler, such as an M12 coupler. The second mating mechanism may comprise a camming latch for mating with a quick connect/disconnect plug coupler having a spring-biased coupler sleeve that self-rotates to lock with the camming latch of the receptacle coupler, upon the plug coupler being aligned with and then simply pushed towards the hybrid receptacle coupler for coupling the hybrid receptacle coupler to a second type of plug coupler. In this manner, the hybrid receptacle coupler is matable with different plug couplers via different mechanisms without requiring modification of the receptacle coupler.

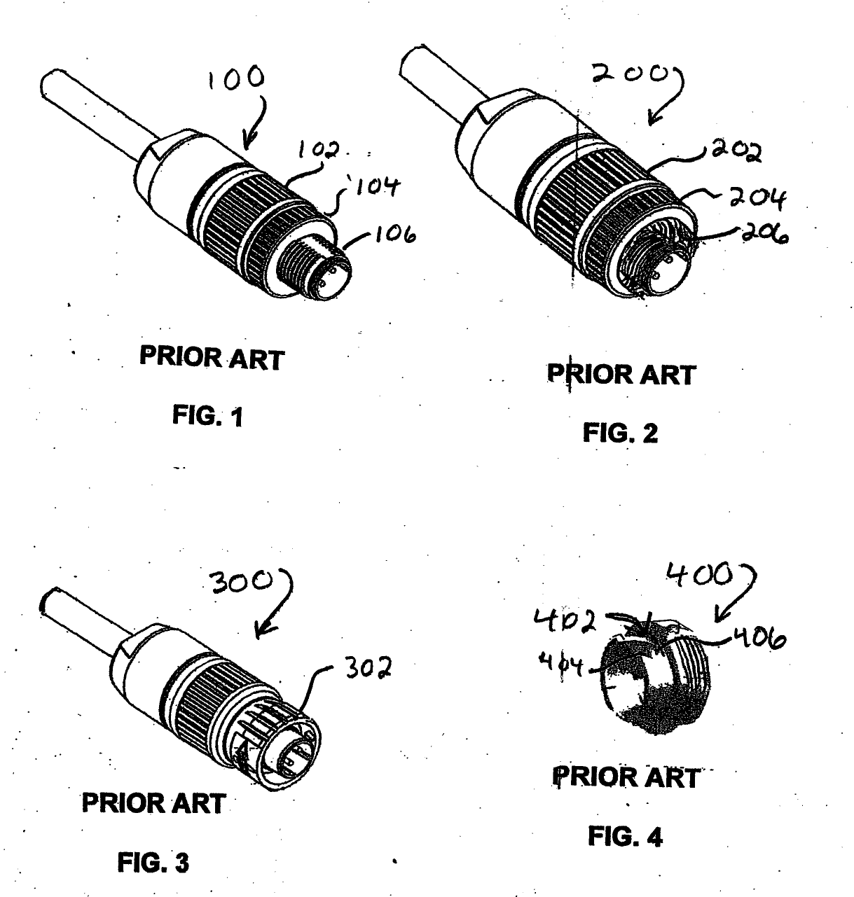

FIGS. 1 and 2 illustrate conventional PRIOR ART threaded plug couplers suitable for mating with an embodiment of the hybrid connector half of the present invention. As shown, a plug coupler 100 of the prior art contains a multicontact connector within housing 102, and a coupling ring 104 mounted around housing 102 adjacent to the mating face. Coupling ring 104 is so mounted to be rotatable with respect to housing 102 and the connector therewithin. Extending forwardly from the rotatable ring is a plug section 106 having external threads to be threaded into a complementary receptacle coupler (not shown) for coupling, to hold the respective connectors in a fully mated condition.

The plug coupler 200 of the prior art contains a multicontact connector within housing 202, similar to the plug coupler 100, and a coupling ring 204 is mounted around housing 202 adjacent to the mating face. As with coupling ring 104, coupling ring 204 is so mounted to be rotatable with respect to housing 202 and the connector therewithin. However, coupling ring 204 has a threaded internal surface 206 to be threaded onto a complementary receptacle coupler (not shown) having external threads for coupling, to hold the respective connectors in a fully mated condition.

FIGS. 3 and 4 illustrate PRIOR ART complementary quick connect/disconnect couplers similar to those disclosed in U.S. Pat. Nos. 5,067,909 and 5,167,522, which are incorporated herein by reference. One of the connectors is held in a first coupler housing 300 (FIG. 3) to be pushed into coupling with a complementary second coupler housing 400 (FIG. 4) containing the other connector, whereafter a rotational latch system couples the couplers together with the contained connectors held in a mated condition. Receptacle coupler 400 is adapted for panel mounting through a cutout thereof. The first coupler housing 300 includes movably secured therearound a latching collar 302 at its forward end that automatically moves slightly in a rotational direction against spring bias during coupling with a camming latch 402 of coupler 400. Camming latch 402 of coupler 400 includes a circumferentially extending angled camming surface 404 engaged by an inwardly directed protrusion defining a cam follower (not shown) of collar 302, thereby camming the collar 302 a selected an angular distance in a first angular direction whereafter the cam follower seats behind a latch surface 406 as spring bias urges the collar in the opposite angular direction. For delatching and decoupling of the couplers during unmating, the latching collar 302 is slightly rotated manually against the spring bias whereupon the coupler 300 is simultaneously pulled away from coupler 400.

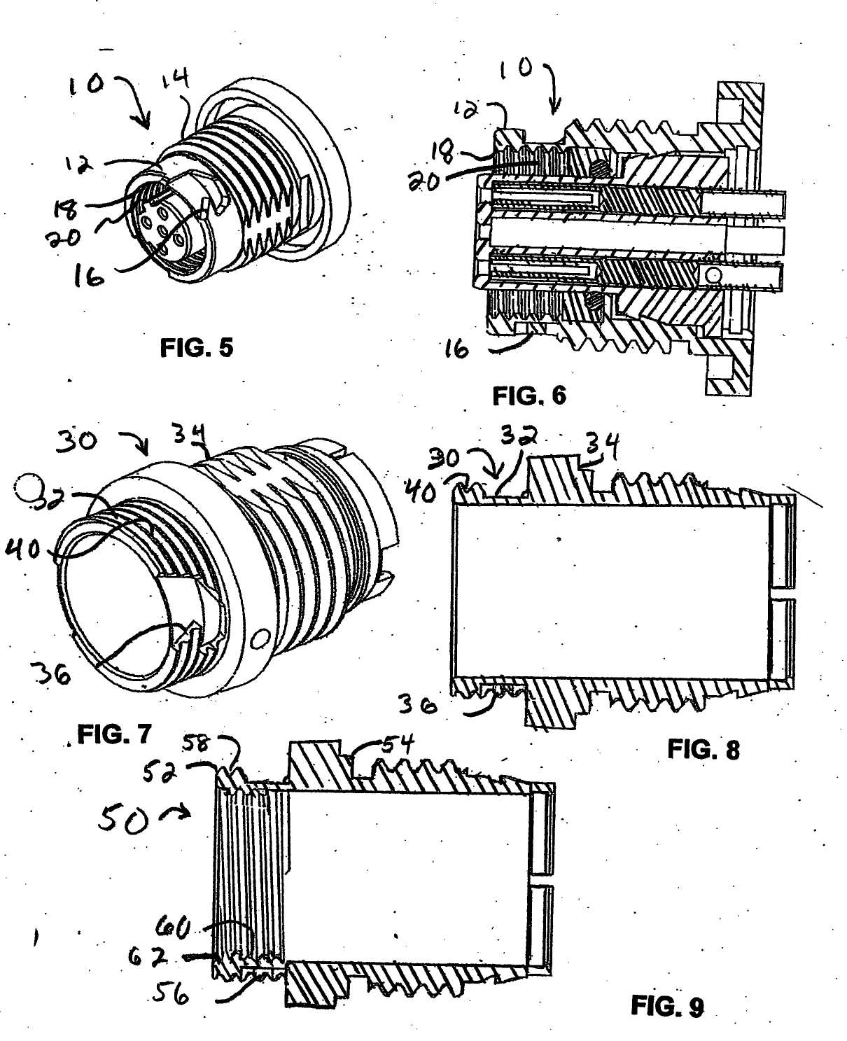

In FIGS. 5 and 6 is illustrated a hybrid receptacle coupler 10 of an illustrative embodiment of the present invention, adapted for panel mounting through a cutout thereof and containing a first multicontact connector. The illustrative hybrid receptacle connector 10 is configured to mate with both a threaded plug coupler, such as an M12 coupler, via a first mating mechanism, and a second type of plug coupler, such as a quick connect/disconnect coupler 300, via a second mating mechanism.

For example, in the illustrative embodiment, on the external surface 12 of housing 14 adjacent the coupling face is defined a first mating mechanism, illustrated as a camming latch 16, for coupling to a first type of complementary connector half, such as the plug coupler 300 of FIG. 3 containing a complementary multicontact connector. The housing also defines a second mating mechanism, illustrated as a threading 20 defined on the internal surface 18 of the housing. The threading 20 enables coupling of the hybrid receptacle coupler 10 to a second type of complementary connector half, such as the plug coupler 100 of FIG. 1 containing a second, complementary multicontact connector. Thus, the same first embodiment of hybrid receptacle connector 10 is couplable with either of two known couplers.

In FIGS. 7 and 8 is illustrated a second embodiment of receptacle connector 30 of an embodiment of the present invention adapted for panel mounting through a cutout thereof (shown without a contained connector). In the embodiment of FIGS. 7 and 8, both the first and second mating mechanisms are formed on the external surface 32 of the receptacle housing 34. For example, as shown, a camming latch 36 for coupling to a plug coupler 300 of FIG. 3 is formed on the external surface 32 of housing 34 adjacent the coupling face. The second mating mechanism, comprising a threading 40 enabling coupling to a plug coupler 200 of FIG. 2, is also formed on the external surface 32. Thus the same second embodiment of hybrid receptacle coupler 30 is couplable with either of two known couplers.

And in FIG. 9 is illustrated a third embodiment of hybrid receptacle connector 50 of the present invention adapted for panel mounting through a cutout thereof (shown without a contained connector). The hybrid receptacle connector 50 of FIG. 9 includes three different mating mechanisms to facilitate mating with three different types of complementary connector halves. For example, as shown in FIG. 9, the illustrative hybrid connector includes a camming latch 56, forming a first mating mechanism, defined on the external surface 52 of housing 54, as in the first two embodiments. A threading 58, forming a second mating mechanism, is also defined on external surface 52. A different threading 60 is formed on internal surface 62 to define a third mating mechanism. Thus, the third embodiment of hybrid receptacle connector 50 is couplable to any of plug couplers 100, 200, 300 of FIGS. 1, 2 and 3.

Such a hybrid coupler is thus backwards compatible with standard threaded couplers as well as with a quick connect/disconnect coupler.

One skilled in the art will recognize that the invention is not limited to the illustrative mating mechanisms, and that the hybrid connector half may include any suitable mating mechanism, in addition to threads and camming latches. For example, one of the first and second mating mechanisms may be configured to mate with the Fixcon® connector available from Lumberg, Inc. of Midlothian, Va. One of the mating mechanisms may comprise a groove at the base of the receptacle connector half, a bayonet-type of mating mechanism and other means known in the art.

In addition, the invention is not limited to a hybrid receptacle connector. Rather, the use of different mating mechanisms to allow a connector half to mate with a plurality of different complementary connector halves may also be applied to a plug coupler as well.

The present invention has been described relative to an illustrative embodiment. Since certain changes may be made in the above constructions without departing from the scope of the invention, it is intended that all matter contained in the above description or shown in the accompanying drawings be interpreted as illustrative and not in a limiting sense. For example, one skilled in the art will recognize that the instrument of the illustrative embodiment of the invention is not limited to use with polyaxial screws and can be used with any suitable implant for any suitable orthopedic system.

It is also to be understood that the following claims are to cover all generic and specific features of the invention described herein, and all statements of the scope of the invention which, as a matter of language, might be said to fall therebetween.

1. A hybrid coupler comprising:
a substantially tubular connector body having an outer surface and an inner surface;
a first mating mechanism disposed in a first location on the body for coupling the tubular connector body to a first complementary connector half;
a second mating mechanism disposed in a second location on the body for coupling the tubular connector body to a second complementary connector half.

2. The hybrid coupler of claim 1, wherein the first mating mechanism is provided on the outer surface of the tubular connector body.

3. The hybrid coupler of claim 1, wherein the second mating mechanism is provided on the inner surface of the tubular connector body.

4. The hybrid coupler of claim 1, wherein the first mating mechanism and the second mating mechanism are provided on the outer surface of the tubular connector body.

5. The hybrid coupler of claim 1, further comprising a third mating mechanism disposed in a third location on the body for coupling the tubular connector body to a third complementary connector half.

6. The hybrid coupler of claim 1, wherein the first mating mechanism comprises a camming latch defined on the outer surface, for mating with quick connect plug coupler.

7. The hybrid coupler of claim 1, wherein the camming latch includes a circumferentially extending angled camming surface configured to engage an inwardly directed protrusion defining a cam follower of a collar on the first complementary connector half and a latch surface for retaining the cam follower to lock the collar to the tubular connector body.

8. The hybrid coupler of claim 1, wherein the second mating mechanism comprises a threading for mating with a complementary threaded surface of the second complementary connector half.

9. The hybrid coupler of claim 8, wherein the threading is provided on the inner surface of the tubular connector body.

10. The hybrid coupler of claim 8, wherein the threading is provided on the outer surface of the tubular connector body.

11. The hybrid coupler of claim 8, wherein the threading is provided on both the outer surface and the inner surface of the tubular connector body.

12. The hybrid coupler of claim 1, wherein the substantially tubular connector body is a receptacle coupler for housing a receptacle of a connector system.

13. A receptacle coupler comprising:
a substantially tubular connector body having an outer surface and an inner surface;
a camming latch defined on the outer surface of the substantially tubular connector body for selectively coupling the tubular connector body to a complementary quick connect/disconnect plug coupler having a first body having a rotatable collar mounted thereon, a spring for biasing the collar in a selected angular orientation and a cam follower protrusion formed on an inner surface of the collar configured to mate with the camming latch to automatically couple the plug coupler to the receptacle coupler; and
a threading defined on one of the outer surface and the inner surface for selectively coupling the tubular connector body to a threaded plug coupler having a coupling ring mounted and freely rotatable therearound and a plug section having a threaded surface for mating with the threading on the substantially tubular connector body.

14. The receptacle coupler of claim 13, wherein the threading is defined on the outer surface.

15. The receptacle coupler of claim 13, wherein the threading is defined on the inner surface.

16. The receptacle coupler of claim 13, wherein the threading is defined on both the outer surface and the inner surface.

17. A connector system comprising:
a hybrid receptacle coupler comprising a body, first mating mechanism disposed on a first location on the body and a second mating mechanism disposed on a second location on the body;
a first plug having a first complementary mating mechanism configured to mate with the first mating mechanism to selectively couple the hybrid receptacle coupler to the first plug; and
a second plug having a second complementary mating mechanism configured to mate with the second mating mechanism to selectively couple the hybrid receptacle coupler to the second plug.

18. The connector system of claim 17, further comprising:
a third mating mechanism on the hybrid receptacle coupler; and
a third plug having a third complementary mating mechanism configured to mate with the third mating mechanism to selectively couple the hybrid receptacle coupler to the third plug.

19. The connector system of claim 17, wherein
the first mating mechanism comprises a camming latch; and
the first plug comprises a first body having a rotatable collar mounted thereon, a spring for biasing the collar in a selected angular orientation and a cam follower protrusion formed on an inner surface of the collar configured to automatically mate with the camming latch when the first plug and the hybrid receptacle coupler are pushed together.

20. The connector system of claim 17, wherein
the second mating mechanism comprises a threaded surface; and
the second plug comprises a second body having a complementary threaded coupling surface configured to engage the threaded surface of the hybrid receptacle coupler and a coupling ring configured to rotate with respect to the hybrid receptacle coupler to fully mate the hybrid receptacle coupler and the second plug.
